(19) United States
(12) Patent Application Publication
(10) Pub. No.: US 2012/0123758 A1
(43) Pub. Date: May 17, 2012

(54) Virtual Environment For Critical Incident Response Training

(75) Inventor: Sherrene Kevan, Cambridge (CA)

(73) Assignee: ENVIROQUEST, LTD., Cambridge (CA)

(21) Appl. No.: 13/212,290

(22) Filed: Aug. 18, 2011

Related U.S. Application Data
(60) Provisional application No. 61/374,808, filed on Aug. 18, 2010.

(51) Int. Cl. G06G 7/48

(52) U.S. Cl. 703/6

(57) ABSTRACT

Methods, systems, and computer-readable media for critical incident response training are disclosed. A method of prompting a user of a computing device to choose how a user avatar should interact with a three-dimensional virtual environment in response to a critical incident includes displaying the three-dimensional virtual environment on a display device. The three-dimensional virtual environment graphically represents a physical environment. The method further includes displaying the user avatar that represents the user on a display device. The user avatar is positioned in the three-dimensional virtual environment. The method further includes simulating the critical incident in the three-dimensional virtual environment, and prompting the user to choose how the user avatar should interact with the three-dimensional virtual environment in response to the simulated critical incident.

### CLAIM OF PRIORITY

This application claims the benefit of U.S. Provisional Application No. 61/374,808, entitled “Virtual Environment for Critical Incident Response of Lockdown Procedures,” filed Aug. 18, 2010, which is hereby incorporated by reference.

### BACKGROUND

1. Field

The present invention relates to systems and methods for virtual environments for critical incident response training and/or lockdown procedures.

2. Technical Background

A critical incident may be defined as a serious situation that can occur at any institution, e.g. a bomb threat, an armed person, an assault, a biohazardous spill, an animal rights protest or damaging activities of research labs, civil disobedience, an electrical outage, a fire or an explosion, a gas leak, winter weather storms (and other natural disasters), infectious diseases, computer failure leading to loss of building operations (e.g., air exchange, heating, water unavailability), a terrorist threat, a suicide, or a sexual assault. A lockdown may occur if a critical incident makes it unsafe to evacuate or enter a building.

Although many employees may be generally aware of these types of situations, most are not properly trained as to what to do when a critical incident occurs and may not understand the critical incident response procedures, including potential lockdown procedures. At present, there are very few employees that are trained on how to react when a critical incident occurs in their workplace. Many classrooms do not have a communication device that can be used to relay information to security, fire, or other emergency response team members.

Accordingly, a need exists for alternative methods and systems for critical incident response training.

### SUMMARY

In one embodiment, a method of prompting a user of a computing device to choose how a user avatar should interact with a three-dimensional virtual environment in response to a critical incident includes displaying the three-dimensional virtual environment on a display device. The three-dimensional virtual environment graphically represents a physical environment. The method further includes displaying the user avatar that represents the user on a display device. The user avatar is positioned in the three-dimensional virtual environment. The method further includes simulating the critical incident in the three-dimensional virtual environment, and prompting the user to choose how the user avatar should interact with the three-dimensional virtual environment in response to the simulated critical incident.

In another embodiment, a system for prompting a user to choose how a user avatar should interact with a three-dimensional virtual environment in response to a critical incident includes a computing device including a non-transitory memory component that stores a set of executable instructions that causes the computing device to display the three-dimensional virtual environment on a display device. The three-dimensional virtual environment graphically represents a physical environment. The set of executable instructions further cause the computing device to display the user avatar that represents the user on a display device. The user avatar is positioned in the three-dimensional virtual environment. The set of executable instructions further cause the computing device to simulate the critical incident in the three-dimensional virtual environment and prompt the user to choose how the user avatar should interact with the three-dimensional virtual environment in response to the simulated critical incident.

In yet another embodiment, a non-transitory computer-readable medium for prompting a user to choose how a user avatar should interact with a three-dimensional virtual environment in response to a critical incident that stores a set of executable instructions that, when executed by a computing device, causes the computing device to display the three-dimensional virtual environment on a display device. The three-dimensional virtual environment graphically represents a physical environment. The non-transitory computer-readable medium that stores a set of executable instructions further causes the computing device to display the user avatar that represents the user on a display device. The user avatar is positioned in the three-dimensional virtual environment. The non-transitory computer-readable medium that stores a set of executable instructions further causes the computing device to simulate the critical incident in the three-dimensional virtual environment and prompt the user to choose how the user avatar should interact with the three-dimensional virtual environment in response to the simulated critical incident.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 depicts a schematic illustration of a trainee computing device, illustrating hardware and software that may be utilized in the trainee computing device, according to one or more embodiments described and illustrated herein;

FIG. 2 depicts a schematic illustration of an exemplary critical incident response training system, including a trainee computing device from FIG. 1, according to one or more embodiments described and illustrated herein; and

FIG. 3 depicts a schematic illustration of an administrator computing device from FIG. 2, further illustrating hardware and software that may be utilized in the administrator computing device, according to one or more embodiments described and illustrated herein.

### DETAILED DESCRIPTION

Embodiments are directed to a training module system comprising a training module for critical incident response in a virtual environment. Emergency lockdown procedures may be incorporated into the training modules, creating virtual environment scenarios for testing a trainee, such as an employee. The training module system may comprise a computer and a display device that allows a user to view a virtual environment including graphical representations of the user, potential emergency responders, other employees or trainees, and virtual site maps related to the workplace in a virtual environment. Training modules may be displayed on the computer of a trainee, such as an employee, in a three-dimensional virtual environment and may be accessed through an administrator computing device, such as an employer mainframe, personal computer, or other computing device. The user's computer may be linked to an Emergency Response Group (e.g., fire and police department, designated health and safety officers, etc.) though the training module system.

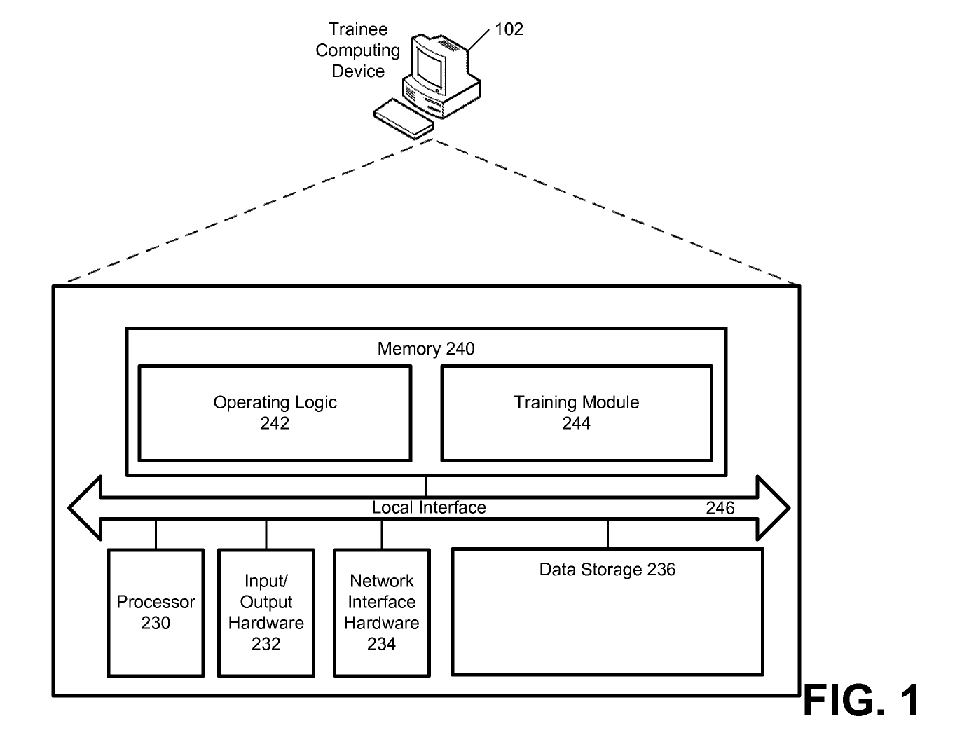

Referring now to the drawings, FIG. 1 depicts a trainee computing device 102, further illustrating a critical incident response training system computing device and/or a non-transitory computer-readable medium for use in a critical incident response training system embodied as hardware, software, and/or firmware, according to embodiments shown and described herein. While in some embodiments, the trainee computing device 102 may be configured as a general purpose computer with the requisite hardware, software, and/or firmware, in some embodiments, the trainee computing device 102 may be configured as a special purpose computer designed specifically for performing the functionality described herein.

As also illustrated in FIG. 1, the trainee computing device 102 may include a processor 230, input/output hardware 232, network interface hardware 234, a data storage component 236 (which may store training modules for use in critical incident response training), and a memory component 240. The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242 and a training module 244 (each of which may be embodied as a computer program, firmware, or hardware, as an example). A local interface 246 is also included in FIG. 1 and may be implemented as a bus or other interface to facilitate communication among the components of the trainee computing device 102.

The processor 230 may include any processing component configured to receive and execute instructions (such as from the data storage component 236 and/or memory component 240). The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 236 may reside local to and/or remote from the trainee computing device 102 and may be configured to store one or more pieces of data for access by the trainee computing device 102 and/or other components.

Included in the memory component 240 are the operating logic 242 and the training module 244. The operating logic 242 may include an operating system and/or other software for managing components of the trainee computing device 102. As described in more detail below, the training module 244 may reside in the memory component 240 and may be configured to permit a user to participate in a simulation of a critical incident in a virtual environment by manipulating a user avatar that represents the user.

The training module 244 may be configured so that a three-dimensional virtual environment that is displayed on a display device, such as a monitor, of the trainee computing device 102. The displayed three-dimensional virtual environment may be a graphical representation of a physical environment in which the user of the trainee computing device 102 is to be trained to respond to critical incidents. The physical environment represented by the three-dimensional virtual environment may include physical environments such as, for example, a business, an airport, a train station, a subway station, a bus station, a university, a college, a school, a portion of or an entire city, or any other physical environment in which critical incident response may be required. The training module 244 may include one or more buildings or building designs (e.g., Computer-aided drafting drawings) customized to the physical environment in which the user may be exposed to and/or required to respond to a critical incident at such location. The user or an administrator may input customized information pertaining to the actual physical environment, including the number of buildings, the type of buildings, the floor plans of the buildings, the layout of rooms and hallways in the buildings, etc. The input information may be substantially replicated in the virtual environment. The buildings may form a campus setting, an airport, a train station or depot, a subway station or depot, a bus station or depot, at least a portion of or an entire city, a restaurant, or a military facility, among other settings. Customizing the virtual environment to the physical environment likely to be encountered by a trainee may enhance the effectiveness of the training. The building designs may provide locations within the virtual environment such as offices, classrooms, storerooms, hallways, stairwells, elevators, bathrooms, meeting rooms, food preparation areas, and any other space allocations where a critical incident may occur.

A user avatar representing a user of the trainee computing device 102 may also be displayed on a display device, such as a monitor or display panel, of trainee computing device 102. The user avatar may displayed to the user from a first person point of view, in which the user views the virtual three-dimensional environment as if looking through the eyes of the user avatar, or from a third person point of view, in which the user can see a graphical representation of the avatar on the screen as the avatar interacts with the three-dimensional virtual environment on the display device. The avatar may be positioned within the three-dimensional virtual environment.

The user or an administrator may input data to personalize the attributes of the user avatar. For example, the user may be able to input attributes, such as, a name, a hair color, a skin color, a height, a weight, a body type, an eye color, etc., that will be reflected in the graphical representation of the user avatar displayed to the user. The use of an avatar that is personalized to represent a user of the trainee computing device 102 in conjunction with the three-dimensional virtual environment may enhance the training of the user to respond to a critical incident. The critical incident response training of a user that involves a virtual environment and an avatar representing the user may be enhanced because of the poteus effect, which may cause the user to believe he or she is part of a real situation, thereby causing the user to enhance his or her reaction to the situation and retention of the training.

A critical incident may be simulated in the three-dimensional virtual environment and the user may be prompted to choose how the user avatar, which represents the user, should interact with the three-dimensional virtual environment to respond to the simulated critical incident.

The training module 244 may be further configured to include emergency decision diagrams and flowcharts of exits, entrances, and designated safety areas. The training module 244 may also include partial lockdown procedures whereby normal workday activities may continue but the workers are unable to enter or exit an area until it becomes safe.

A question and answer component of a critical incident response test may be incorporated into the training module 244. The question and answer component may display a question to the user on a display device, prompt the user to input an answer to the question, and provide feedback to the user in response to the user's answer.

The training module 244 may be password protected, ensuring that only users authorized to receive the training have access to the training. Further, training module 244 may be portable, in that it may be accessed using any computer within an employer's domain. The training module 244 may also generate supply lists that may be needed to carry out sufficient safety procedures.

As an example and not a limitation, a trainee may log onto a computer for entry into a particular training module. The trainee may choose the avatar that she wants to represent her. A selection of avatars from which to choose from may be provided to the user. For example, each avatar may be presented in a box and when the trainee clicks on the box to select one of the available avatars, the non-selected avatars will no longer be available for use during the training session. According to one embodiment, avatars representing emergency responders, health and safety officers, and teachers, for example, may also be pre-selected and assigned before training begins.

The virtual environment training may be initiated by the user clicking on a start button. When the training begins, the trainee's avatar may be put in a simulated critical incident response scenario and given choices of how to proceed. The training module 244 may evaluate the user's choice to determine if the choice is correct in the simulated critical incident. A correct choice may lead the user to another scenario. An incorrect choice may result in the trainee computing device 102 displaying the consequences of the choice in the three-dimensional virtual environment. The user may proceed through a training sequence until all stages of the training sequence have been completed. In addition, in one illustrative embodiment, the training module 244 may time how long it takes the user to make his/her one or more choices in response to the simulated critical incident. The training module 244 may also provide feedback and correlated consequences to both the choice and the time it took for the user to make that choice.

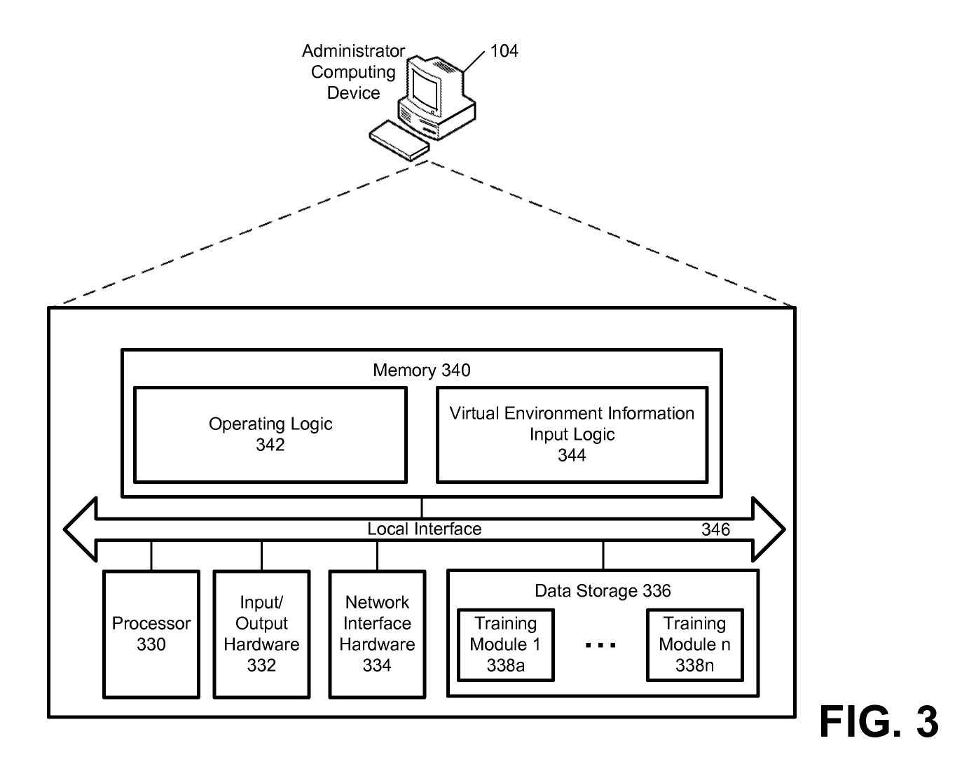

It should be understood that the components illustrated in FIG. 1 are merely exemplary and are not intended to limit the scope of this disclosure. More specifically, while the components in FIG. 1 are illustrated as residing within the trainee computing device 102, this is merely an example. In some embodiments, one or more of the components may reside external to the trainee computing device 102. Similarly, while FIG. 1 is directed to the trainee computing device 102, other components such as the other trainee computing devices and the administrator computing device 104, described in detail in FIG. 3 below, may include similar hardware, software, and/or firmware.

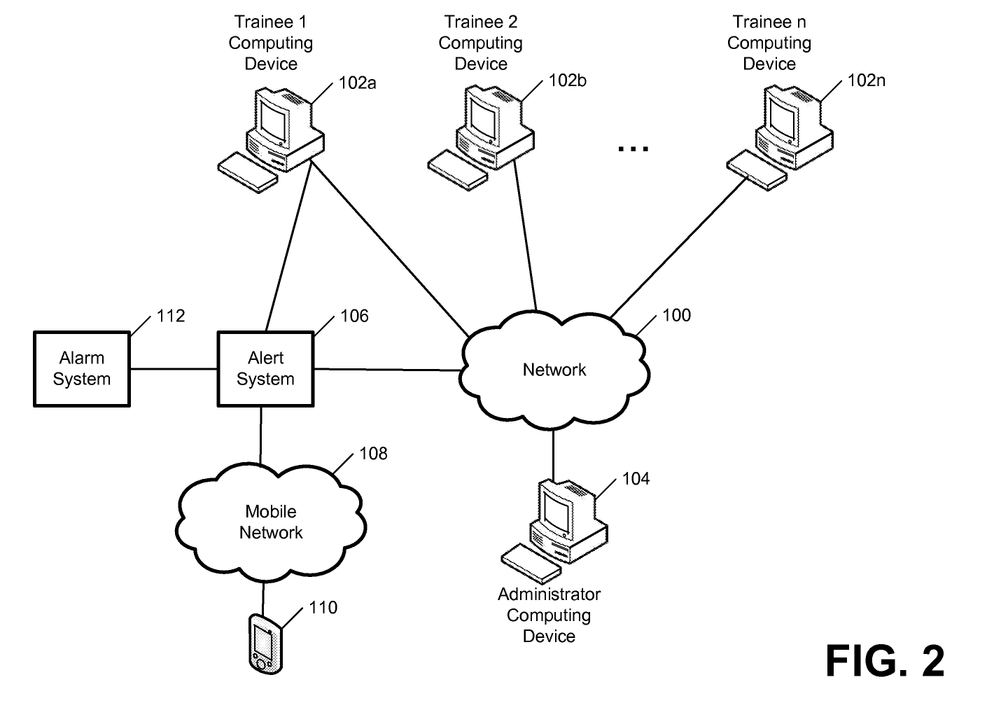

FIG. 2 depicts an exemplary computing network, illustrating components for a critical incident response training system, according to embodiments shown and described herein. The critical response training system illustrated in FIG. 2 generally comprises a computer network 100, one or more trainee computing devices (e.g., trainee 1 computing device 102a, trainee 2 computing device 102b, . . . , trainee n computing device 102n), an administrator computing device 104, an alert system 106, a mobile network 108, a mobile device 110, and an alarm system 112. While the critical response training system of FIG. 2 comprises a computer network 100, multiple trainee computing devices, an administrator computing device 104, an alert system 106, a mobile network 108, a mobile device 110, and an alarm system 112, in other embodiments, a critical incident response training system may comprise only a trainee computing device (e.g., trainee 1 computing device 102a) that executes instructions that cause the computing device to display a three-dimensional virtual environment that a user can interact with, using an avatar, in a critical response scenario.

As illustrated in FIG. 2, computer network 100 may include a wide area network, such as the internet, a local area network (LAN), a mobile communications network, a public service telephone network (PSTN) and/or other network and may be configured to electronically connect a trainee computing device with other trainee computing devices and/or an administrator computing device 104.

As illustrated by the training system of FIG. 2, multiple users remotely located from one another may participate in a training scenario at the same time. For example, each user of a participating trainee computing device may have an associated user avatar that is present in and interacts with a three-dimensional virtual environment common to all of the participating trainees. Further, the training system of FIG. 2 may allow actual local emergency support personnel, such as firemen and police, to participate in training because the local emergency support personnel could simply utilize a trainee computing device that would generate an associated avatar that would be present in the three-dimensional virtual environment experienced by all trainees.

The trainee 1 computing device 102a may also be coupled with an alert system 106. The alert system 106 may use other technologies, such as cell phones to alert security or others when an incident is occurring. The alert system 106 may comprise a “panic button” that would send a communication directly to a security office when the button is pressed, from which the location of the incident could be determined. The alert system 106 may be coupled to an alarm system 112 (e.g., an alarm system of a facility in which trainee 1 computing device 102a is located), which may activate the alarm system 112. The alert system 106 may also be configured to send out an email blast to other trainee computing device, other computers, and/or other cell phones (such as mobile device 110) via computer network 100 or mobile network 108, in order to alert users of a lockdown situation.

The mobile network 108 may include a mobile communications network, a public service telephone network (PSTN), a wide area network, such as the Internet, a local area network (LAN) and/or other network and may be configured to electronically connect a mobile device to an alert system 106.

The trainee computing devices 102a, 102b, . . . , 102n, may electronically receive the training module from administrator computing device 104 via computer network 100. A trainee computing device may transmit data representing a user's choice in response to a simulated critical incident or answers to questions asked of the user, to the administrator computing device 104, either during training or after training is complete. The administrator computing device 104 may receive training information from the trainee computing device. The administrator computing device 104 may analyze and/or compile the training information, and subsequently revise critical incident response procedures and/or lockdown procedures based on the analysis.

It should be understood that while the trainee computing devices 102a, 102b, . . . , 102n and the administrator computing device 104 are depicted as personal computers, these are merely examples. More specifically, in some embodiments any type of computing device (e.g. mobile computing device, personal computer, server, smart phones, etc.) may be utilized for any of these components. Additionally, while each of these computing devices is illustrated in FIG. 2 as a single piece of hardware, this is also an example. More specifically, each of the trainee computing devices 102a, 102b, . . . , 102n and the administrator computing device 104 may represent a plurality of computers, servers, databases, etc.

FIG. 3 depicts the administrator computing device 104 from FIG. 2, further illustrating a component of a critical incident response training system and/or a non-transitory computer-readable medium for use in a critical incident response training system embodied as hardware, software, and/or firmware, according to embodiments shown and described herein. While in some embodiments, the administrator computing device 104 may be configured as a general purpose computer with the requisite hardware, software, and/or firmware, in some embodiments, the administrator computing device 104 may be configured as a special purpose computer designed specifically for performing the functionality described herein.

As also illustrated in FIG. 3, the administrator computing device 104 may include a processor 330, input/output hardware 332, network interface hardware 334, a data storage component 336 (which may store training modules 338a, . . . , 338n, for use in critical incident response training), and a memory component 340. The memory component 340 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 340 may be configured to store operating logic 342 and virtual environment information input logic 344 (each of which may be embodied as a computer program, firmware, or hardware, as an example). A local interface 346 is also included in FIG. 3 and may be implemented as a bus or other interface to facilitate communication among the components of the administrator computing device 104.

The processor 330 may include any processing component configured to receive and execute instructions (such as from the data storage component 336 and/or memory component 340). The input/output hardware 332 may include a monitor, keyboard, mouse, printer, camera, microphone, speaker, and/or other device for receiving, sending, and/or presenting data. The network interface hardware 334 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 336 may reside local to and/or remote from the administrator computing device 104 and may be configured to store one or more pieces of data for access by the administrator computing device 104 and/or other components.

Included in the memory component 340 is the operating logic 342 and the virtual environment information input logic 344. The operating logic 342 may include an operating system and/or other software for managing components of the administrator computing device 104. The virtual environment information input logic 344 may reside in the memory component 340 and may be configured to display a template through which a user of the administrator computing device 104 inputs specific information about the virtual environment for which the administrator may design a critical incident response training module. By way of example and not limitation, virtual environment information input logic 344 may be configured to display a template through which security personnel at a university may input specific information about the campus setting, allowing employees of the university to be trained for their particular workplace.

It should be understood that the components illustrated in FIG. 3 are merely exemplary and are not intended to limit the scope of this disclosure. More specifically, while the components in FIG. 3 are illustrated as residing within the administrator computing device 104, this is merely an example. In some embodiments, one or more of the components may reside external to the administrator computing device 104. Similarly, while FIG. 3 is directed to the administrator computing device 104, other components such as trainee computing devices coupled to the administrator computing device 104 via computer network 100 may include similar hardware, software, and/or firmware.

Embodiments described herein may aid in developing a workforce that is well-trained in critical incident response and lockdown procedures. Additionally, remote and multidisciplinary participation may be enabled because the virtual environment does not require all of the trainees to be physically located in the same room, building, or city, so training opportunities drastically increase. Utilizing the embodiments described herein, training of multiple employees or members of an organization may be completed on an individual basis, which may result in cost savings because employees of an Emergency Operations Group may not have to spend as much time and money training others. Embodiments may allow actual local and/or Federal emergency support personnel such as, for example, firemen and police, to participate in training in addition to employees or personnel of a facility and/or organization, and may also reduce insurance costs by reducing liability.

What is claimed is:

1. A method of prompting a user of a computing device to choose how a user avatar should interact with a three-dimensional virtual environment in response to a critical incident comprising:
displaying the three-dimensional virtual environment on a display device, wherein the three-dimensional virtual environment graphically represents a physical environment;
displaying the user avatar that represents the user on a display device, wherein the user avatar is positioned in the three-dimensional virtual environment;
simulating the critical incident in the three-dimensional virtual environment; and
prompting the user to choose how the user avatar should interact with the three-dimensional virtual environment in response to the simulated critical incident.

2. The method of claim 1 further comprising displaying on a display device emergency decision diagrams and flowcharts corresponding to the critical incident.

3. The method of claim 1 further comprising:
displaying a question to the user on a display device;
prompting the user to input an answer to the question; and
providing feedback to the user in response to the answer.

4. The method of claim 1 further comprising transmitting data representing the user response to the critical incident to an administrator.

5. The method of claim 4 further comprising revising critical incident response procedures in response to the transmitted data.

6. The method of claim 1, wherein the physical environment comprises a business, an airport, a train, a subway, a bust station, a university, a college, or a school.

7. The method of claim 1, wherein the three-dimensional virtual environment comprises one or more buildings.

8. The method of claim 7, wherein the one or more buildings form a campus setting, an airport, a train station or depot, a subway station or depot, a bus station or depot, at least a portion of a city, a restaurant, or a military facility.

9. The method of claim 7, wherein a building of the one or more buildings comprises an office, a classroom, a storeroom, a hallway, an elevator, a stairwell, a bathroom, a meeting room, or a food preparation area.

10. The method of claim 1 further comprising:
evaluating the choice of the user to determine if the choice is the correct choice in the simulated critical incident; and
simulating the result of an incorrect choice in the three-dimensional virtual environment.

11. The method of claim 1 further comprising:
evaluating the choice of the user to determine if the choice is the correct choice in the simulated critical incident;
simulating a next stage of the critical incident in the three-dimensional virtual environment; and
prompting the user to choose how the user avatar should proceed in response to the next stage of the simulated critical incident.

12. The method of claim 1 further comprising:
prompting the user or an administrator to input customized information relating to the physical environment; and
receiving the customized information, wherein displaying the three-dimensional virtual environment on the display device is based on the customized information.

13. The method of claim 1, wherein the user avatar is displayed to the user from a first person point of view or a third person point of view.

14. The method of claim 1 further comprising:
prompting the user or an administrator to input user avatar attributes such as a name, a hair color, a skin color, a height, a weight, a body type, or an eye color;
receiving the user avatar attributes, wherein displaying the user avatar on the display device is based on the user avatar attributes.

15. A system for prompting a user to choose how a user avatar should interact with a three-dimensional virtual environment in response to a critical incident comprising:
a computing device that comprises a non-transitory memory component that stores a set of executable instructions that causes the computing device to:
display the three-dimensional virtual environment on a display device, wherein the three-dimensional virtual environment graphically represents a physical environment;
display the user avatar that represents the user on a display device, wherein the user avatar is positioned in the three-dimensional virtual environment;
simulate the critical incident in the three-dimensional virtual environment; and
prompt the user to choose how the user avatar should interact with the three-dimensional virtual environment in response to the simulated critical incident.

16. The system of claim 15, wherein the set of executable instructions further causes the computing device to:
evaluate the choice of the user to determine if the choice is the correct choice in the simulated critical incident; and
simulate the result of an incorrect choice in the three-dimensional virtual environment.

17. The system of claim 15, wherein the set of executable instructions further causes the computing device to:
evaluate the choice of the user to determine if the choice is the correct choice in the simulated critical incident;
simulate a next stage of the critical incident in the three-dimensional virtual environment; and
prompt the user to choose how the user avatar should proceed in response to the next stage of the simulated critical incident.

18. A non-transitory computer-readable medium for prompting a user to choose how a user avatar should interact with a three-dimensional virtual environment in response to a critical incident that stores a set of executable instructions that, when executed by a computing device, causes the computing device to perform at least the following:
display the three-dimensional virtual environment on a display device, wherein the three-dimensional virtual environment graphically represents a physical environment;
display the user avatar that represents the user on a display device, wherein the user avatar is positioned in the three-dimensional virtual environment;
simulate the critical incident in the three-dimensional virtual environment; and
prompt the user to choose how the user avatar should interact with the three-dimensional virtual environment in response to the simulated critical incident.

19. The non-transitory computer-readable medium of claim 18, wherein the set of executable instructions further causes the computing device to:
evaluate the choice of the user to determine if the choice is the correct choice in the simulated critical incident; and
simulate the result of an incorrect choice in the three-dimensional virtual environment.

20. The non-transitory computer-readable medium of claim 18, wherein the set of executable instructions further causes the computing device to:
evaluate the choice of the user to determine if the choice is the correct choice in the simulated critical incident;
simulate a next stage of the critical incident in the three-dimensional virtual environment; and;
prompt the user to choose how the user avatar should proceed in response to the next stage of the simulated critical incident.
